(19) United States
(12) Patent Application Publication
(10) Pub. No.: US 2011/0263836 A1
(43) Pub. Date: Oct. 27, 2011

(54) METHOD FOR REDUCTION OF LIGHT-INDUCED YELLOWING OF LIGNIN-CONTAINING MATERIAL

(75) Inventors: Veli-Matti Vuorenpalo, Espoo (FI); Jaakko Pere, Vantaa (FI); Reijo Aksela, Espoo (FI); Andrei Tauber, Koln (DE)

(73) Assignee: KEMIRA OYJ, Helsinki (FI)

(21) Appl. No.: 12/989,136

(22) PCT Filed: Apr. 17, 2009
(86) PCT No.: PCT/EP2009/054605

§ 371 Date: Dec. 17, 2010

(30) Foreign Application Priority Data
Apr. 22, 2008 (FI) 20085345

(51) Int. Cl. C08H 7/00; D21C 3/04; D21C 3/00

(52) U.S. Cl. 530/500; 162/72; 162/76; 162/75

(57) ABSTRACT

A method for treating lignin-containing fibrous material to reduce its susceptibility to yellowing generally includes enzymatically stabilizing the lignin of the material with an oxidizing agent capable of oxidizing phenolic or similar groups, which may undergo reactions conductive to the formation of colored sites on the fibers, and treating the material with a fluorescent whitening agent. Also disclosed are lignin-containing materials obtained by the method.

### FIELD OF THE INVENTION

The present invention relates to a method for treating lignin-containing fibrous material to reduce its susceptibility to yellowing. More particularly, the present invention relates to such method comprising treating the material with a fluorescent whitening agent.

### BACKGROUND OF THE INVENTION

It is well-known in the art that light (UV light in particular), heat, moisture, and chemicals can give rise to changes in the brightness of lignin-containing material, such as cellulose pulps. Usually such changes result in reduced reflectivity, particularly in the blue light region. This phenomenon is known as brightness reversion or yellowing and can be caused by various factors depending on which type of lignin-containing material is concerned. Heat and moisture are the main causes of the brightness reversion of chemical (lignin-free) pulps, whereas mechanical pulps mostly yellow when they are exposed to light. The brightness reversion of mechanical pulps also varies depending on the raw material (type of wood), production method (with or without chemical pretreatment) and after-treatment (bleaching with different reagents) used. Thus, for instance, sulfonation and peroxide bleaching greatly increase the susceptibility of pulp to light-induced yellowing.

The brightness reversion of lignocellulosic materials, such as pulps, and product made from such material, can be reduced in various ways, e.g. by means of impregnation of surface treatment using UV screens, antioxidants or polymers, or by coating the surface with a coating layer or a layer of non-yellowing chemical pulp. Various additives are described in patent literature. For example, U.S. Pat. No. 4,978,363 discloses a composition and method for treating fibers based on a mixture of an organopolysiloxane having at least one amino-substituted hydrocarbon radical directly bonded to a silicon atom and a higher fatty carboxylic acid. The carboxylic acid reacts with the amino radicals to reduce yellowing and oxidation of the fiber treatment.

U.S. Pat. No. 6,599,326 discloses inhibition of pulp and paper yellowing using hydroxylamines and other coadditives. Chemical pulps and papers, especially kraft pulps and papers, which may still contain traces of lignin, have enhanced resistance to yellowing when they contain an effective stabilizing amount of an N,N-dialkylhydroxylamine, an ester, amide or thio substituted N,N-dialkylhydroxylamine or N,N-dibenzylhydroxylamine or an ammonium salt thereof.

WO 2005/061782 discloses a process for producing a fiber material having reduced susceptibility to yellowing comprising activating the fibers of the matrix with an oxidizing agent capable of oxidizing phenolic or similar structural groups, which may undergo reactions conducive to the formation of colored sites on the fibers, and attaching to the oxidized sites at least one modifying agent to block the reactivity of the oxidized sites.

Many of the additives that have been found to prevent yellowing are expensive or problematic from an environmental point of view. Some are only effective when introduced in amounts so large that they may have a negative effect on other properties of the product or be uneconomical. Accordingly, there is still a need for methods for preventing yellowing.

### SUMMARY OF THE INVENTION

It is an aim of the present invention to eliminate the problems of the prior art and to provide new methods for reducing or preventing yellowing. The methods aim at effectively reducing light-induced brightness reversion of lignin-containing fibrous materials, such as pulps.

It was surprisingly found out that use of the modifying agent as disclosed in WO 2005/061782 is not necessarily required but that the use of an oxidizing agent alone is enough to stabilize the lignin. Furthermore, it was discovered that when the lignin-containing material was further treated with a fluorescent whitening agent after the stabilization, it provided an advantageous synergic effect and reduced the oxidizing-agent-based drop in initial brightness. Lignin structure seems to be modified in such a way that unfavorable side reactions are reduced.

The present invention provides a method for treating lignin-containing fibrous material to reduce its susceptibility to yellowing, comprising stabilizing the lignin of the material with an oxidizing agent capable of oxidizing phenolic or similar groups, which may undergo reactions conductive to the formation of colored sites on the fibers, and treating the material with a fluorescent whitening agent.

The present invention also provides a lignin-containing material obtained by said method.

### BRIEF DESCRIPTION OF THE DRAWINGS

FIG. 1 shows the brightness curve of modified and non-modified pulp during the irradiation test (Xenotest 150S, irradiation 1100 Wh/m²).

FIG. 2 shows the brightness curve of modified and non-modified pulp during the irradiation test (Xenotest 150S, irradiation 1100 Wh/m²).

### DETAILED DESCRIPTION OF THE INVENTION

The present invention provides a method for treating lignin-containing fibrous material to reduce its susceptibility to yellowing. The “lignin-containing material” refers to any suitable lignin-containing material which may be susceptible to yellowing. Examples of lignin-containing materials comprise mechanical pulp, chemimechanical pulp, (sawn) timber, straw, bamboo, bagasse, jute, flax, hemp, lignin-containing wood-free material and lignin-containing textile fibers.

The lignin-containing materials usually contain a fiber matrix comprising fibers containing phenolic or similar structural groups, which are capable of being oxidized by suitable oxidizing agents. Such fibers are typically “lignocellulosic” fiber materials, which include fiber made of annual or perennial plants or wooden raw material by, for example, mechanical, chemimechanical or chemical pulping. During industrial refining of wood by, e.g., refiner mechanical pulping (RMP), pressurized refiner mechanical pulping (PRMP), thermomechanical pulping (TMP), groundwood (GW) or pressurized groundwood (PGW) or chemithermomechanical pulping (CTMP), a woody raw material, derived from different wood species as for example hardwood and softwood species, is refined into fine fibers in processes, which separate the individual fibers from each other. The fibers are typically split between the lamellas along the interlamellar lignin layer, leaving a fiber surface which is at least partly covered with lignin or lignin-compounds having a phenolic basic structure

Within the scope of the present invention, also chemical pulps are included if they are susceptible to brightness reversion and have a residual content of lignin sufficient to give at least a minimum amount of phenolic groups necessary for providing binding sites for the modifying agent. Generally, the concentration of lignin in the fiber matrix should be at least 0.1 weight percent (wt-%), preferably at least about 1.0 wt-%.

Onefeature of the invention is to block brightness reversion by modifications of phenolic hydroxyls, alpha-carbonyls and/or alpha-hydroxyls on the fibers. In particular, by subjecting lignin structures to enzymatic oxidation to yield oxidized groups of the afore-said kind, the normal reactions causing brightness reversion can be attained.

In the method of the present invention the lignin-containing material is stabilized with an oxidizing agent capable of oxidizing phenolic or similar groups, which may undergo reactions conductive to the formation of colored sites on the fibers. The stabilization is directed to the lignin and may be carried out enzymatically or chemically. In the stabilization OH-groups are formed which stabilize the structure and prevent the yellowing. In other words, the parts causing the yellowing are deactivated.

Typically, the stabilizing agent is an enzyme and the enzymatic reaction is carried out by contacting the lignin-containing material with an oxidizing agent, which is capable—in the presence of the enzyme—of oxidizing the phenolic or similar structural groups to provide oxidized lignin-containing material. Such oxidizing agents are selected from the group of oxygen and oxygen-containing gases, such as air, and hydrogen peroxide. Oxygen can be supplied by various means, such as by efficient mixing, foaming, gases enriched with oxygen or oxygen supplied by enzymatic or chemical means, such as peroxides to the solution. Peroxides can be added or produced in situ.

According to one embodiment of the invention, the oxidative enzymes capable of catalyzing oxidation of phenolic groups are selected from e.g. the group of phenol oxidases (E.C.1.10.3.2 benzenediol:oxygen oxidoreductase) and catalyzing the oxidation of o- and p-substituted phenolic hydroxyl and amino/amine groups in monomeric and polymeric aromatic compounds. The oxidative reaction leads to the formation of phenoxy radicals. Other groups of enzymes comprise peroxidases and other oxidases. “Peroxidases” are enzymes which catalyze oxidative reaction using hydrogen peroxide as their electron acceptor, whereas “oxidases” are enzymes which catalyze oxidative reactions using molecular oxygen as their electron acceptor.

Examples of suitable enzymes include laccases (EC 1.10.3.2), catechol oxidases (EC 1.10.3.1), tyrosinases (EC 1.14.18.1), bilirubin oxidases (EC 1.3.3.5), horseradish peroxidase (EC 1.11.1.7), manganese peroxidase (EC 1.11.1.13) and lignin peroxidase (EC 1.11.1.14). In one embodiment the stabilization is carried out by using laccase.

The amount of the enzyme is selected depending on the activity of the individual enzyme and the desired effect on the lignin-containing material. Advantageously, the enzyme is employed in an amount of 0.0001-10 milligrams (mg) protein/gram (g) of dry matter lignin-containing material.

Different dosages can be used, but advantageously a dosage of about 1 to about 100 000 nkat/g, and in other embodiments, 10 to 500 nkat/g is sufficient.

In addition to enzymes, also chemical agents, such as alkali metal persulfates and hydrogen peroxide and other per-compounds, can be used for achieving oxidization of the phenolic groups and for forming phenoxy radicals. The dosage of the chemical agent is, depending on the chemical agent and the lignin-containing material (i.e. on the amount of phenolic groups contained therein), typically in the range of about 0.01 to about 100 kg/ton, preferably about 0.1 to about 50 kg/ton, e.g. about 0.5 to about 20 kg/ton. In the case of chemical agents, no separate oxidation agent needs to be added. The per-compound will achieve the aimed oxidation of the phenolic groups.

The stabilization treatment is carried out in a liquid medium, preferably in an aqueous medium, such as in water or an aqueous solution, at a temperature in the range of 5 to 100° C., typically about 10 to 85° C. Typically, a temperature of 20 to 80° C. is preferred. The consistency of the pulp is, generally, 0.5 to 95% by weight, typically about 1 to about 50% by weight, in particular about 2 to about 40% by weight. The pH of the medium is preferably slightly acidic; in particular the pH is about 2 to 10 at room temperature in the case of phenol oxidases. The chemical agents are usually employed in slightly acidic conditions, such as at pH 3 to 6. Peroxidases are typically employed at pH of about 3 to 12. The reaction mixture is stirred during oxidation. Other enzymes can be used under similar conditions, preferably at pH 2 to 10.

In the method of the present invention the material is further treated with a fluorescent whitening agent (FWA). In one embodiment the fluorescent whitening agent is a compound of the formula (I):

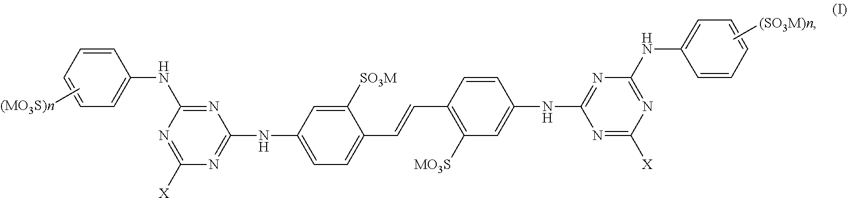

wherein n is an integer number from 0 to 2, M is an alkali metal ion or optionally substituted ammonium ion, and X is N-alkylamino or N,N-dialkylamino, where the alkyl radicals in the combined terms N-alkylamino and N,N-dialkylamino are to be understood as meaning those having up to 4 carbon atoms, which may be interrupted by an O atom and/or may carry, as a substituent, hydroxyl, carbamoyl, cyano or sulfo, and when it is N,N-dialkylamino, the two alkyl radicals which are optionally interrupted by a heteroatom selected from O, N and S, together with the N-atom to which they are bonded may form a saturated 5- or 6-membered heterocycle.

Generally FWA is added to pulp or paper machine wet-end as an aqueous solution of active molecule (such as the one represented by formula (I)), which may include some additives (e.g., to improve solubility or performance) or it may just be FWA-water solution as such. This is known as “FWA formulation”. In the method of the present invention, the lignin-containing material may be treated with a fluorescent whitening agent or any suitable formulation thereof.

Also a special pretreatment step may be combined with the stabilization and FWA treatment. When the lignin-containing material is pretreated with a reducing agent before the stabilization, it provides an advantageous synergic effect and reduces the oxidizing-agent-based drop in initial brightness. Lignin structure seems to be modified in such a way that unfavorable side reactions are reduced.

In such embodiment the lignin-containing material is pretreated with a reducing agent. Examples of suitable reducing agents include boron hydride, such as sodium boron hydride (sold e.g., by trade name Borino® by Finnish Chemicals Oy), dithionite (hydrosulfite), bisulfate, sulfur dioxide water or mixtures thereof. The reducing agent does not particularly act as a bleaching chemical at this step but acts more as a fiber modification agent.

The method of WO 2005/061782 may also be applied to the present invention. In such a case, after the stabilization the material is further treated with a modifying agent to block the reactivity of the oxidized sites. In one embodiment the modifying agent is a brightness reversion inhibitor. The modifying agent has at least one functional site or reactive structure which provides for binding of the modifying compound to the lignocellulosic material, in particular in the oxidized phenolic groups or corresponding chemical structures of the lignin-containing material, which have been oxidized during the stabilization step.

The modifying agent can be an aliphatic or aromatic, monocyclic, bicyclic or tricyclic substance. The aliphatic compound can be an unsaturated carboxylic acid, advantageously a monocarboxylic unsaturated fatty acid, having 4 to 30 carbon atoms. In particular, the modifying agent can be a monocarboxylic, unsaturated fatty acid containing a minimum of two double bonds, preferably two conjugated double bonds. Such fatty acids have an even number of carbon atoms, typically in the range of 16 to 22. It is also possible to use lower alkanols, i.e. alcoholic compounds comprising 1 to 6, in particular 1 to 4 carbon atoms. Examples include n- and i-propanol and n- and t-butanol.

Examples of particularly suitable compounds are constituted by linoleic and linolenic acid. It would appear that the unsaturated fatty acid bonds to the oxidized groups or structure via one of the double bonds. In one embodiment, linoleic acid (LA) is used, preferably in combination with activation carried out by using laccase enzyme.

Other suitable compounds include antioxidants, such as tocopherol and beta-carotene. The compound can have special properties, such as capability to trap radicals and form colorless substituents.

After the above processing, the modified lignin-containing material having new and improved properties is generally separated from the liquid reaction and further used in target applications, such as high quality consumer packaging and graphic papers.

The following non-limiting examples illustrate the invention.

### EXAMPLES

### Example 1

The treatments were started by cold disintegration of peroxide bleached aspen/spruce CTMP pulps. The pulps were additionally washed twice with water (80° C.) after the disintegration. The bonding was started by mixing 5 g of o.d. pulp with water, the pH of the pulp slurry was adjusted to pH 7. Thereafter, laccase (Trametes Hirsuta) was added (10 nkat/g). Laccase induced activation time was 1 min at 55° C. The linoleic acid (LA) was dissolved first in 1 ml of acetone and then added to the pulp slurry dropwise. Mixing time after addition of the LA was 39 min (55° C.). The dosage corresponded to 0.075 mmol linoleic acid/g pulp. The total treatment time was 40 min. After the treatment the pulp was filtrated twice and washed with water (with an amount equal to 20× dry weight).

After the enzymatic treatment the pulp was suspended into distilled water at a consistency of 0.625%. Fluorescent whitening agent (FWA) was diluted to a concentration of 0.5% and then added to pulp slurry at the desired final concentration (5 kg/t_{o.d. pulp}). After addition pulp was mixed for 10 min at RT covered from day light by aluminium foil and black plastic bag.

The reference treatment was performed with identical procedure, but without the addition of the enzyme, LA or FWA.

After all treatments the pulps were mixed in water in a concentration of 5 g/l and disintegrated 5000 revs before preparation of two handsheets/treatment on wire cloth according to SCAN M 5:75.

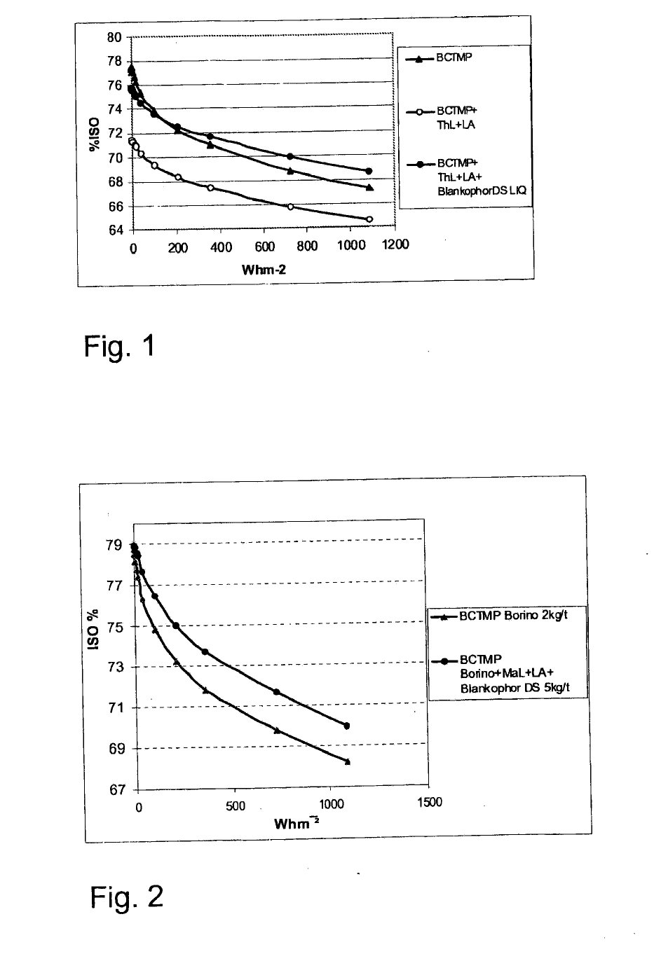

Aspen BCTMP shows clear indications of light induced yellowing when subjected to light irradiation by Xenotest device (FIG. 1). When pulp is modified by laccase (ThL) and further treated with LA, the brightness stability measured as delta brightness is improved but the initial brightness drops severely. Addition of FWA (5 kg/t as a product, Blankophor DS) raised the ISO brightness very close to the original value. The light stability also stays at a very good level compared to reference pulp. In this sense FWAs can also be considered to counteract the detrimental effect of brightness drop by laccase in general.

### Example 2

The treatments were started by reductive treatment of the peroxide bleached aspen/spruce CTMP pulps. Pulps were diluted to the consistency of 10%, tempered to 60° C. prior to addition of Borino®. Charge of Borino was 0.1% and treatment time 3 minutes. During treatment pH was controlled to be >9. After treatment pulps were diluted with fresh water and washed twice with water.

The pulps were additionally washed twice with water (80° C.) after the disintegration. The bonding was started by mixing 5 g of o.d. pulp with water, and the pH of the pulp slurry was adjusted to pH 7. Thereafter laccase (MaL) was added (10 nkat/g). Laccase induced activation time was 1 min at 55° C. The linoleic acid (LA) was dissolved first in 1 ml of acetone and then added to the pulp slurry dropwise. Mixing time after addition of the LA was 39 min (55° C.). The dosage corresponded to 0.075 mmol linoleic acid/g pulp. The total treatment time was 40 min. After the treatment, the pulp was filtrated twice and washed with water (with an amount equal to 20× dry weight).

After the enzymatic treatment the pulp was suspended into distilled water at a consistency of 0.625%. Fluorescent whitening agent (FWA) was diluted to a concentration of 0.5% and then added to pulp slurry at the desired final concentration (5 kg/t_{o.d. pulp}). After addition, pulp was mixed for 10 min at RT covered from day light by aluminium foil and black plastic bag.

The reference treatment was performed with identical procedure, but without the addition of the enzyme, LA or FWA.

After all treatments the pulps were mixed in water in a concentration of 5 g/l and disintegrated 5000 revs before preparation of two handsheets/treatment on wire cloth according to SCAN M 5:75.

As seen previously, aspen BCTMP shows clear indications of light induced yellowing when subjected to light irradiation by Xenotest device. When pulp is modified by laccase and LA treatment and further treated with FWA (5 kg/t as a product, Blankophor DS) good brightness stability can be achieved (FIG. 1). The effect can be further enhanced by a reductive treatment prior the laccase modification. FIG. 2 clearly shows how the Borino treated pulp responses very well to the above-mentioned treatment.

1. A method for treating lignin-containing fibrous material to reduce its susceptibility yellowing, comprising:
enzymatically stabilizing the lignin of the material with an oxidizing agent capable of oxidizing phenolic or similar groups, which may undergo reactions conducive to the formation of colored sites on the fibers; and
treating the material with a fluorescent whitening agent.

2. The method of claim 1, wherein the lignin-containing fibrous material is bleached lignin-containing fibrous material.

3. The method of claim 1, wherein the fibrous material is treated with the fluorescent whitening agent after the stabilization.

4. The method of claim 1, wherein the oxidizing agent is selected from peroxidases and oxidases.

5. The method of claim 1, wherein the oxidizing agent is selected from the group consisting of laccases, catechol oxidases, tyrosinases, bilirubin oxidases, horseradish peroxidase, manganese peroxidase and lignin peroxidase.

6. The method of claim 1, wherein the fluorescent whitening agent is a compound of formula (I): 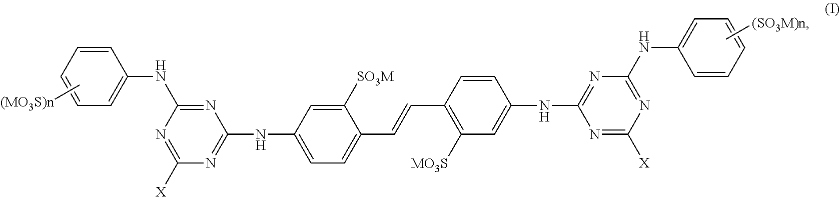
wherein n is an integer number from 0 to 2,
M is an alkali metal ion or optionally substituted ammonium ion, and
X is N-alkylamino or N,N-dialkylamino, where the alkyl radicals in the combined terms N-alkylamino and N,N-dialkylamino are to be understood as meaning those having up to 4 carbon atoms, which may be interrupted by an O atom and/or may carry, as a substituent, hydroxyl, carbamoyl, cyano or sulfo, and when it is N,N-dialkylamino, the two alkyl radicals which are optionally interrupted by a heteroatom selected from O, N and S, together with the N-atom to which they are bonded may form a saturated 5- or 6-membered heterocycle.

7. The method of claim 1, wherein prior to enzymatically stabilizing the lignin of the material, the material is pretreated with a reductive agent.

8. The method of claim 7, wherein the reductive agent is selected from the group consisting of boron hydride, dithionite, bisulfate, sulfur dioxide water, and mixtures thereof.

9. The method of claim 1, wherein prior to enzymatically stabilizing the lignin of the material, the material is further treated with a modifying agent to block reactivity of oxidized sites in the material.

10. The method of claim 9, wherein the modifying agent is a brightness reversion inhibitor.

11. The method of claim 9, wherein the modifying agent is selected from the group consisting of C₁₋₄ alkanols, unsaturated carboxylic acids, monocarboxylic unsaturated fatty acids, monocarboxylic unsaturated fatty acids containing minimum of two double bonds, preferably two conjugated double bonds, linoleic acid, linolenic acid and antioxidants.

12. The method of claim 1, wherein the material is selected from mechanical pulp, chemimechanical pulp, timber, straw, bamboo, bagasse, jute, flax, hemp, lignin-containing wood-free material, and lignin-containing textile fibers.

13. A lignin-containing material obtained by the method of claim 1.
